(19) United States
(12) Patent Application Publication
(10) Pub. No.: US 2025/0377877 A1
(43) Pub. Date: Dec. 11, 2025

(54) METHOD AND DEVICE FOR SUPPORTING FEATURE ON DEMAND

(71) Applicants: HYUNDAI MOTOR COMPANY, Seoul (KR); KIA CORPORATION, Seoul (KR)

(72) Inventor: Seon Il Noh, Hwaseong-si (KR)

(73) Assignees: HYUNDAI MOTOR COMPANY, Seoul (KR); KIA CORPORATION, Seoul (KR)

(21) Appl. No.: 18/974,420

(22) Filed: Dec. 9, 2024

(30) Foreign Application Priority Data
Jun. 5, 2024 (KR) 10-2024-0073600

(51) Int. Cl. G06F 8/61; B60R 16/023; G06Q 20/08; H04L 67/12

(52) U.S. Cl. CPC G06F 8/61; B60R 16/023; G06Q 20/085; H04L 67/12

(57) ABSTRACT

A method supports feature on demand (FoD) services on an electronic device included within a vehicle. The method may include: receiving a request to turn on the vehicle and install an FoD certificate; turning on the vehicle; transmitting information on the vehicle and a component within the vehicle related to an FoD service to an FoD server; receiving an FoD certificate; reporting the completion of receiving the FoD certificate to the FoD server; turning off the vehicle; installing the received FoD certificate; turning on the vehicle; and transmitting the information on the vehicle and the installation result of the FoD certificate.

### CROSS REFERENCE TO RELATED APPLICATION

The present application claims priority to Korean Patent Application No. 10-2024-0073600, filed Jun. 5, 2024, the entire contents of which are incorporated herein for all purposes by this reference.

### BACKGROUND

### Field of the Disclosure

The present disclosure relates to a method and device for supporting Feature on Demand (FoD), and more particularly, to a method and device for remotely installing a FoD certificate in a vehicle.

### Description of the Related Art

Feature on Demand (FoD) service is an optional subscription service that allows selective purchase of vehicle features using wireless communication technology. Unlike the traditional model where features were pre-selected and delivered with the vehicle, FoD services offer customers the flexibility to purchase and activate desired software features on-demand, even after vehicle purchase.

FoD services encompass a wide range of applications including navigation systems, parking distance warning (PDW), surround viewing monitor (SVM), parking collision-avoidance assist (PCA), remote smart parking assist (RSPA), and advanced driver assistance systems (ADAS). Moreover, since these systems are not permanent, users can continue to adjust their selection options over time.

Users can purchase the FoD services wirelessly through an app or website, or by visiting a service center directly. After purchasing the desired service, users must first install the FoD certificate in the vehicle for use. To install the FoD certificate on their vehicle, users must first get in the vehicle, turn the vehicle on, and wait for a while until the FoD certificate is fully received. Once the FoD certificate has been fully received, users may need to turn the vehicle off and follow the procedure to complete the FoD certificate installation by pressing a button. This may cause inconvenience for users. Additionally, while the FoD certificate is being received, the head unit information (e.g., camera screen and map display) may be obscured, hindering user convenience by limiting access to essential information. Furthermore, users who purchase FoD services while outside the vehicle may experience inconvenience as they need to physically enter the vehicle and turn on the head unit and power to confirm the purchased FoD services.

### SUMMARY

Objects of the present disclosure are to provide a method and a device for remotely controlling Feature on Demand (FoD) certificate installation without the user having to physically board or control the vehicle themselves.

Other objects of the present disclosure are to provide a method and a device for remotely controlling FoD certificate installation, which was previously only possible through direct user manipulation of the vehicle's power.

A method for supporting FoD services on an electronic device included within a vehicle according to an embodiment of the present disclosure is provided. The method may include receiving a request to turn on the vehicle and install a FoD certificate and turning on the vehicle. The method may also include transmitting information on the vehicle and a component within the vehicle related to an FoD service to an FoD server. The method may further include receiving an FoD certificate and reporting the completion of receiving, i.e., having received the FoD certificate to the FoD server. The method may also include turning off the vehicle, installing the received FoD certificate, turning on the vehicle, and transmitting the information on the vehicle and the installation result of the FoD certificate.

In a method for supporting FoD services on an electronic device included within a vehicle according to an embodiment of the present disclosure, the information on the vehicle may include at least one of the manufacturer of the vehicle, the specification of the vehicle, the model number of the vehicle, or the manufacturing date of the vehicle. The information on the components with the vehicle related to the FoD service may include at least some of the information about the components necessary within the vehicle to support the FoD service.

In a method for supporting FoD services on an electronic device included within a vehicle according to an embodiment of the present disclosure, the request to turn on the vehicle and install the FoD certificate may be received from a connected car service (CCS) server. The information on the vehicle and the installation result of the FoD certificate may be transmitted to the CCS server.

In a method for supporting FoD services on an electronic device included within a vehicle according to an embodiment of the present disclosure, the installation result of the FoD certificate may include at least one of whether the FoD certificate was installed successfully, the validity period of the FoD certificate, or the installation date of the FoD certificate.

A method for supporting FoD services on an electronic device included within a vehicle according to an embodiment of the present disclosure may further include turning off the vehicle after transmitting the information on the vehicle and the installation result of the FoD certificate.

An electronic device included in a vehicle supporting FoD services according to an embodiment of the present disclosure is provided. The electronic device may include a communication unit configured to perform communication, i.e., communicate with a connected car service (CCS) server and a FoD server outside the vehicle and communication among components inside the vehicle. The electronic device may also include a control unit configured to: receive a request to turn on the vehicle and install an FoD certificate; turn on the vehicle; transmit information on the vehicle and a component within the vehicle related to the FoD service to the FoD server; receive an FoD certificate; report the completion of receiving, i.e., having received the FoD certificate to the FoD server; turn off the vehicle; and transmit the information on the vehicle and the installation result of the FoD certificate. The electronic device may also include an FoD control unit configured to install the received FoD certificate.

In an electronic device included in a vehicle supporting FoD services according to an embodiment of the present disclosure, the information on the vehicle may include at least one of the manufacturer of the vehicle, the specification of the vehicle, the model number of the vehicle, or the manufacturing date of the vehicle. The information on the components with the vehicle related to the FoD service may include at least some of the information about the components necessary within the vehicle to support the FoD service.

In an electronic device included in a vehicle supporting FoD services according to an embodiment of the present disclosure, the control unit may communicate with the CCS server to request to turn on the vehicle and may install the FoD certificate and transmit the information on the vehicle and the installation result of the FoD certificate.

In an electronic device included in a vehicle supporting FoD services according to an embodiment of the present disclosure, the installation result of the FoD certificate may include at least one of whether the FoD certificate was installed successfully, the validity period of the FoD certificate, or the installation date of the FoD certificate.

In an electronic device included in a vehicle supporting FoD services according to an embodiment of the present disclosure, the control unit may turn off the vehicle after transmitting the information on the vehicle and the installation result of the FoD certificate.

A method for supporting FoD services of an electronic device according to an embodiment of the present disclosure is provided. The method may include requesting to purchase an FoD certificate or subscribe to an FoD service, receiving a request to activate a menu related to the installation of the FoD certificate, activating the menu related to the installation of the FoD certificate, requesting to install the FoD certificate, and receiving the installation result of the FoD certificate.

In a method for supporting FoD services of an electronic device according to an embodiment of the present disclosure, the menu related to the installation of the FoD certificate may be an application menu of an application installed on the electronic device.

In a method for supporting FoD services of an electronic device according to an embodiment of the present disclosure, the requesting to purchase the FoD certificate or subscribe to the FoD service may be performed through an application installed on the electronic device or a website accessed by the electronic device.

In a method for supporting FoD services of an electronic device according to an embodiment of the present disclosure, the installation result of the FoD certificate may include at least one of whether the FoD certificate was installed successfully, the validity period of the FoD certificate, or the installation date of the FoD certificate.

A method for supporting FoD services of an electronic device according to an embodiment of the present disclosure may further include displaying the received installation result of the FoD certificate.

An electronic device supporting FoD services according to an embodiment of the present disclosure is provided. The electronic device may include a display, a communication unit, and a processor. The processor may be configured to request to purchase an FoD certificate or subscribe to an FoD service, receive a request to activate a menu related to the installation of the FoD certificate, activate the menu related to the installation of the FoD certificate, request to install the FoD certificate, and receive the installation result of the FoD certificate.

In an electronic device supporting FoD services according to an embodiment of the present disclosure, the menu related to the installation of the FoD certificate may be an application menu of an application installed on the electronic device.

In an electronic device supporting FoD services according to an embodiment of the present disclosure, the processor may request to purchase the FoD certificate or subscribe to the FoD service through an application installed on the electronic device or a website accessed by the electronic device.

In an electronic device supporting FoD services according to an embodiment of the present disclosure, the installation result of the FoD certificate may include at least one of whether the FoD certificate was installed successfully, the validity period of the FoD certificate, or the installation date of the FoD certificate.

In an electronic device supporting FoD services according to an embodiment of the present disclosure, the control unit may display the received installation result of the FoD certificate on the display.

### BRIEF DESCRIPTION OF THE DRAWINGS

FIG. 1 is a diagram illustrating a system for remotely controlling a vehicular Feature on Demand (FoD) service according to an embodiment of the present disclosure;

FIGS. 2A and 2B are signal flow diagrams illustrating remote installation of FoD certificates in a vehicle according to an embodiment of the present disclosure;

FIG. 3 is a flowchart illustrating the operation of a first electronic device according to an embodiment of the present disclosure;

FIG. 4 is a flowchart illustrating the operation of a second electronic device according to an embodiment of the present disclosure;

FIG. 5 is a block diagram of a first electronic device according to an embodiment of the present disclosure; and

FIG. 6 is a block diagram a block diagram of a second electronic device according to an embodiment of the present disclosure.

### DETAILED DESCRIPTION

Hereinafter, embodiments of the present disclosure are described in detail with reference to the accompanying drawings.

However, the technical concepts of the present disclosure are not limited to the embodiments described herein. The technical concepts and embodiments can be implemented in various other forms, allowing for selective combination or substitution of one or more components among different embodiments within the scope of the technical concepts of the present disclosure.

Unless explicitly defined otherwise, terms used in the embodiments of the present disclosure (including technical and scientific terms) should be interpreted as having meanings understood by those having ordinary skill in the art to which the present disclosure pertains considering the context of the technology involved, rather than solely based on their usual or dictionary meanings.

Furthermore, the terminology employed in the embodiments of the present disclosure is intended solely for the purpose of elucidating the embodiments and should not be construed as limiting the scope of the present disclosure. When a controller, module, component, device, unit, element, or the like of the present disclosure is described as having a purpose or performing an operation, function, or the like, the controller, module, component, device, unit, element, or the like should be considered herein as being “configured to” meet that purpose or to perform that operation or function. Each controller, module, component, device, unit, element, and the like may share or may separately embody or be included with a processor and a memory, such as a non-transitory computer readable media, as part of the apparatus.

In this specification, singular language may include the plural unless specifically mentioned otherwise. Also, when stated as “at least one (or one or more) of A, B, and (or) C,” it may include any of A, B, or C alone, and may include one or more of all possible combinations of A, B, and C.

Additionally, when describing the components of the embodiments of the present disclosure, terms such as “first,” “second,” “A,” “B,” “(a),” and “(b)” may be used.

These terms are intended solely for the purpose of distinguishing one component from another and do not limit the essence, order, or sequence of respective components.

Furthermore, when a component is described as being “connected,” “coupled,” or “attached” to another component, it may include not only direct connection, coupling, or attachment but also connection, coupling, or attachment through another component located between the component and the other component.

Additionally, when a component is described as being formed or placed “on or under” another component, “on (above)” or “under (below)” may include not only cases where two components directly contact each other but also cases where one or more other components are formed or positioned between the two components. Additionally, when expressed as “on (above) or under (below),” it may include not only the upward direction but also the downward direction relative to a single component.

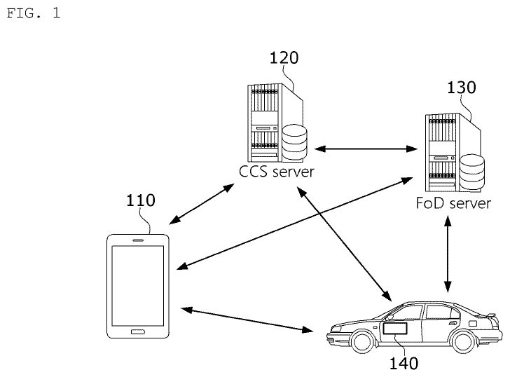

FIG. 1 is a diagram illustrating a system for remotely supporting a vehicular Feature on Demand (FoD) service according to an embodiment of the present disclosure.

With reference to FIG. 1, the system may include a first electronic device 110, a connected car service (CCS) server 120, a FoD server 130, and a second electronic device 140 included within the vehicle.

The first electronic device 110 may be a device equipped with a relevant application or be capable of accessing the corresponding website for purchasing or subscribing to FoD services. The first electronic device 110 may be, for example, a smartphone or tablet personal computer (PC). According to an embodiment, the first electronic device 110 may have an application installed for wireless connection to the vehicle. Once connected wirelessly to the vehicle, the first electronic device 110 may display vehicle information and allow the user to control some vehicle functions.

The CCS server 120, i.e., the connected car service server, is an electronic device that connects to the vehicle via a wireless network. The CCS server 120 may support services such as real-time route navigation, remote vehicle control, and car-to-home/home-to-car functionalities, utilizing the wireless connection to the vehicle.

The FoD server 130 is a server dedicated to supporting FoD services for the vehicle, and the types of FoD services may vary depending on the vehicle. The FoD server 130 is a server, i.e., an electronic device, operated by the vehicle manufacturer. When a user subscribes to or purchases FoD services wirelessly or wired, the FoD server 130 may transmit a FoD certificate to the electronic device installed within the vehicle. The FoD server 130 may request necessary information from the CCS server 120 to install the FoD certificate within the vehicle. This necessary information may be, for example, vehicle information required for FoD certificate installation.

The second electronic device 140 is an electronic device included within the vehicle, which may include a communication unit 142, a control unit 144, and an FoD control unit 146.

The communication unit 142 facilitates wireless or wired communication between the vehicle and other devices, allowing the transmission and reception of necessary information (or instructions, commands, and the like). The communication unit 142 may be referred to as a management control unit, vehicle communication control unit, central communication unit (CCU), or wired/wireless communication integrated control unit. In the present disclosure, the other devices may include at least one of the FoD server 130, CCS server 120, or first electronic device 110. The communication unit 142 may also facilitate the exchange of necessary information among internal components of the vehicle. For example, the communication unit 142 may receive and transmit necessary information from and to the FoD control unit 146 and/or the control unit 144.

The control unit 144 may oversee the overall control of various components within the vehicle. For example, the control unit 144 may manage turn-on and/or turn-off of, i.e., turning on and turning off, the vehicle. Additionally, the control unit 144 may be referred to as the vehicle control unit (VCU), electronic control unit (ECU), or electronic control device.

The FoD control unit 146 may be a device that controls components related to FoD services purchased by the user. For example, when the FoD service pertains to a surround view monitor system, the FoD control unit 146 may be a device that controls front and/or rear cameras. According to an embodiment, the FoD control unit 146 may correspond individually to each FoD service or may act as a comprehensive controller for devices associated with FoD services.

While the second electronic device 140 is described as being divided into the communication unit 142, control unit 144, and FoD control unit 146, it is not excluded that a single component may perform the functions of all these units. Furthermore, the second electronic device 140 may be subdivided into additional components to perform the functions described herein.

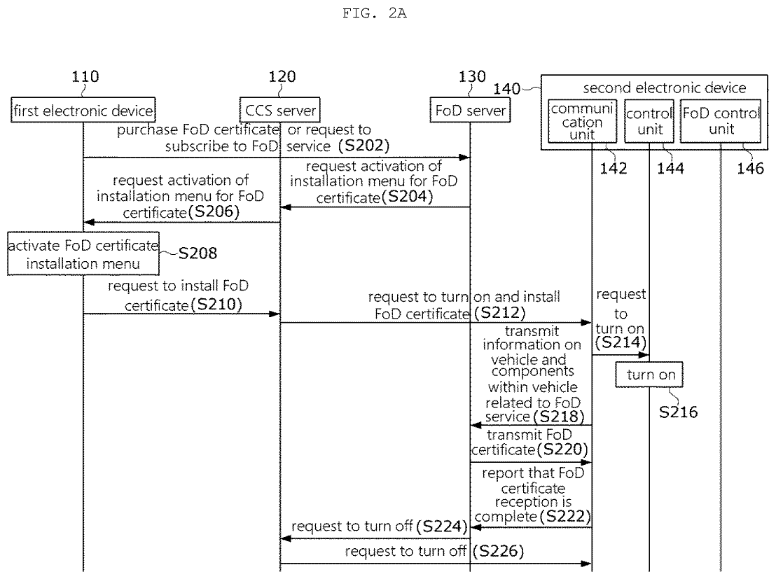

FIGS. 2A and 2B are signal flow diagrams illustrating remote installation of FoD certificates in a vehicle according to an embodiment of the present disclosure.

The first electronic device 110 may connect to the FoD server 130 at step S202 to purchase an FoD certificate or subscribe to an FoD service. The first electronic device 110 may be a smartphone or tablet PC under the control of the user.

Upon the first electronic device 110 purchasing an FoD certificate or subscribing to an FoD service, the FoD server 130 may request activation of the installation menu for the purchased FoD certificates from the CCS server 120 at step S204. Even when the first electronic device 110 subscribes to an FoD service, the FoD server 130 may also request the CCS server 120 to activate the installation-related menu for the certificate associated with the subscribed FoD service, as the installation of the corresponding FoD certification is required.

At step S206, the CCS server 120 may request the first electronic device 110 to activate the installation-related menu for the FoD certificate, allowing the user to install the FoD certificate using the first electronic device 110. The FoD certificate may be installed on electronic devices within the vehicle.

According to an embodiment, the FoD server 130 may request activation of the installation menu for the purchased FoD certificate on the first electronic device 110 when the first electronic device 110 purchases an FoD certificate or subscribes to an FoD service.

Upon receiving a request to activate the installation menu for the FoD certificate, the first electronic device 110 may activate a menu on the display allowing installation of the FoD certificate at step S208. According to an embodiment, the first electronic device 110 may have an application installed for wireless connection to the vehicle, and the menu for installing the FoD certificate may be one of the menus, i.e., an application menu in the installed application. The menu for installing the FoD certificate may be a button or a new window but is not limited thereto. The user may initiate the installation of the FoD certificate using the activated menu.

Once the installation of the FoD certificate is initiated by the user, the first electronic device 110 may transmit an FoD certificate installation request to the CCS server 120 at step S210. Upon establishing a connection with the CCS server 120 through the application, the first electronic device 110 may transmit information on the vehicle in which the FoD certificate is to be installed in advance, and then may request the installation of the FoD certificate.

At step S212, the CCS server 120 may request the communication unit 142 of the vehicle to power on and install the FoD certificate. The communication unit 142 serves as a component for wirelessly connecting the vehicle to other devices and may directly receive messages (or commands) from the CCS server 120. The communication unit 142 may request at step S214 the control unit 144, which controls the turn-on of the vehicle, to start the vehicle, and upon receiving the request for turn-on, the control unit 144 may start the vehicle at step S216.

Meanwhile, in response to the request from the CCS server 120 to install the FoD certificate, the communication unit 142 may transmit the information on the vehicle and the components within the vehicle related to the FoD service to the FoD server 130 at step S218. The communication unit 142 may transmit information on the vehicle and the components within the vehicle related to the FoD service to the FoD server 130 in order to receive the appropriate FoD certificate for the vehicle. The information on the components within the vehicle related to the FoD service may include at least some of the information about the components necessary within the vehicle to support the FoD service. For example, when the FoD service is related to the cameras installed in the vehicle, the information on the components within the vehicle related to the FoD service may include information may include at least one of the location of the cameras, specifications of the cameras, or the number of cameras installed.

At step S220, the FoD server 130 may transmit a FoD certificate for the FoD service that the user has purchased or subscribed to the communication unit 142. The FoD certificate may vary depending on the type of vehicle and the components included in vehicles that support the FoD service. Therefore, based on the received information about the vehicle and the components within the vehicle related to the FoD service, the FoD server 130 may transmit the FoD certificate for the FoD service purchased or subscribed by the user to the communication unit 142.

Upon completion of receiving, i.e., having received the purchased FoD certificate, the communication unit 142 may report to the FoD server 130 at step S222 that the reception of the FoD certificate is complete. The communication unit 142 may transmit a reception completion message to the FoD server 130 to notify the completion of the reception of the FoD certificate.

At step S224, the FoD server 130 may request the CCS server 120 to turn off the vehicle.

The CCS server 120 may then request the communication unit 142 at step S226 to turn off the vehicle. The communication unit 142 may request the control unit 144 at step S228 to turn off the vehicle. Upon receiving the request to turn off the vehicle from the communication unit 142, the control unit 144 may turn off the vehicle at step S230.

Additionally, the communication unit 142 may request, at step S232, the FoD control unit 146 to install the FoD certificate. Upon receiving the request, the FoD control unit 146 may install the FoD certificate at step S234.

Once the installation of the FoD certificate is complete, the FoD control unit 146 may transmit an FoD certificate installation completion message to the communication unit 142 at step S236.

Upon receiving the FoD certificate installation completion message, the communication unit 142 may request at step S238 the control unit 144 to turn on the vehicle. The control unit 144 may then turn on the vehicle at step S240, and the FoD control unit 146 may issue an FoD certificate installation status report at step S242.

The communication unit 142, upon receiving the installation status, may transmit the FoD certificate installation result and vehicle information to the FoD server 130 at step S244. Additionally, the communication unit 142 may request at step S252 the control unit 144 to turn off the vehicle. The control unit 144 may then turn off the vehicle at step S254.

The FoD server 130 may transmit the FoD certificate installation result received from the communication unit 142 to the CCS server 120 at step S246.

The CCS server 120 may transmit the FoD certificate installation result received from the FoD server 130 to the first electronic device 110 at step S248.

At step S250, the first electronic device 110 may display the installation result received from the FoD server 130 on the display.

Although depicted as being divided into the communication unit 142, the control unit 144, and the FoD control unit 146 according to their roles or functions in FIGS. 2A and 2B, the second electronic device 140 included in the vehicle may also be configured to perform the corresponding functions as a single component. For example, upon receiving a request from the FoD server 130 to turn on the vehicle, the control unit of the second electronic device 140 may directly turn on the vehicle.

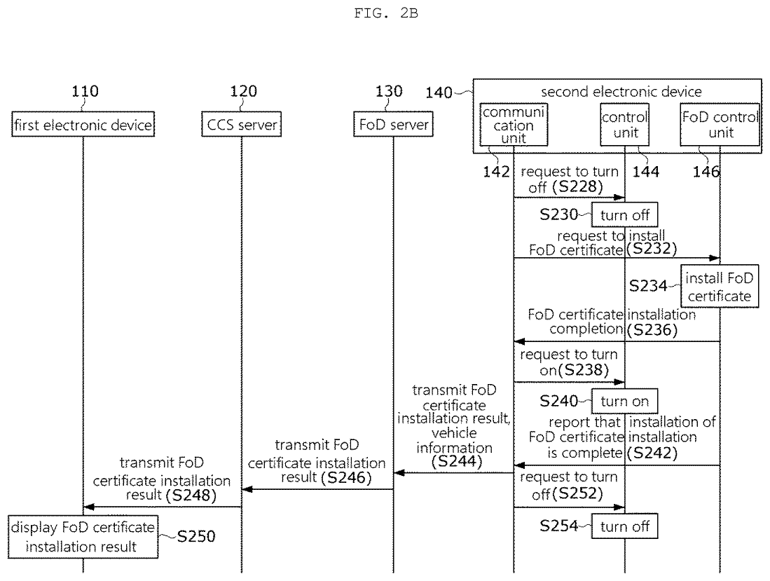

FIG. 3 is a flowchart illustrating the operation of a first electronic device according to an embodiment of the present disclosure.

In FIG. 3, the first electronic device may support users to access the FoD server to purchase FoD certificates or subscribe to FoD services. Additionally, the first electronic device may establish a wireless connection with the vehicle. An application may be installed to display information from the wirelessly connected vehicle or control at least some functions of the vehicle.

With reference to FIG. 3, the first electronic device may connect to the FoD server to purchase an FoD certificate or subscribe to the FoD service at step S310. The first electronic device may access the FoD server via a website or through an application to acquire the FoD certificate or subscribe to the FoD service.

Once the purchase of the FoD certificate or subscription to the FoD service is completed, the first electronic device may receive, at step S320, a request to activate the menu for installing the FoD certificate. The first electronic device may receive this request from the CCS server or from the FoD server.

Upon receiving the request, the first electronic device may activate, at step S330, the menu for installing the FoD certificate. The menu for installing the FoD certificate may be an application menu of the application installed on the first electronic device or may be a web menu on the web page of the company providing the FoD service.

At step S340, the first electronic device may request the installation of the FoD certificate. The first electronic device can request the installation of the FoD certificate to the CCS server.

Once the installation of the FoD certificate is completed, the first electronic device may receive the installation result of the FoD certificate at step S350. The installation result of the FoD certificate may be transmitted from the FoD server to the CCS server and then forwarded to the first electronic device.

The first electronic device may display the received installation result of FoD certificate at step S360. The installation result of FoD certificate may include, for example, at least one of whether the FoD certificate was installed normally, the validity period of the FoD certificate, or the installation date of the FoD certificate.

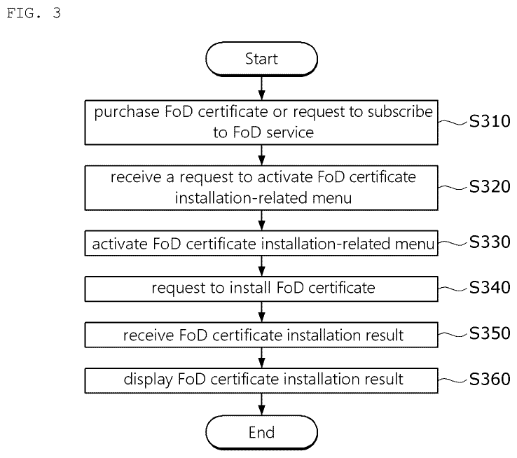

FIG. 4 is a flowchart illustrating the operation of a second electronic device according to an embodiment of the present disclosure.

The second electronic device included within the vehicle may perform communication with other devices and may control other components included within the vehicle to perform functions. The second electronic device may include a communication unit for communication with other devices inside and outside the vehicle depending on its function, a control unit for controlling the components inside the vehicle, or an FoD control unit for supporting FoD services among the vehicle's components.

With reference to FIG. 4, the second electronic device may receive a request for turn-on and/or installation of the FoD certificate at step S410. In detail, the communication unit of the second electronic device may receive a request for vehicle start and/or installation of the FoD certificate.

Upon receiving the request, the second electronic device may first turn on the vehicle at step S415. The second electronic device may receive the request through the communication unit and request the control unit to turn on the vehicle.

After turning on the vehicle, the second electronic device may transmit vehicle information and information about the components within the vehicle related to the FoD service to the FoD server at step S420. Vehicle information may include at least one of the vehicle manufacturer, vehicle specifications, vehicle model number, or vehicle manufacturing date. The information on the components within the vehicle related to the FoD service may include at least some of the information about the components necessary within the vehicle to support the FoD service. For example, when the FoD service is related to the cameras installed in the vehicle, the information on the components within the vehicle related to the FoD service may include at least one of the location of the cameras, specifications of the cameras, or the number of cameras installed.

The second electronic device may receive the FoD certificate from the FoD server at step S435. The FoD server 130 may transmit a FoD certificate tailored to the user's purchased or subscribed FoD service based on the received vehicle information and details of FoD-supporting components, as the FoD certificate may vary depending on the type of vehicle and its components supporting the FoD service.

Once the reception of the FoD certificate is complete, the second electronic device may report the completion of FoD certificate reception to the FoD server at step S430. The second electronic device may transmit a FoD certificate reception completion message to the FoD server.

Subsequently, the second electronic device may receive, at step S435, a request to turn off the vehicle. In more detail, the communication unit of the second electronic device may receive a turn-off request and request the control unit to turn off the vehicle.

After turning off the vehicle, the second electronic device may install the FoD certificate at step S440. The FoD certificate may be installed in the FoD control unit, which supports the FoD service among the vehicle's components.

Once the installation of the FoD certificate is complete, the second electronic device may turn on the vehicle at step S445.

The second electronic device may transmit vehicle information and the installation result of the FoD certificate at step S450. The second electronic device may transmit vehicle information and the installation result of the FoD certificate to the FoD server. The installation result of the FoD certificate may include, for example, at least one of whether the FoD certificate was installed normally, the validity period of the FoD certificate, or the installation date of the FoD certificate.

After transmitting the vehicle information and the installation result of the FoD certificate, the second electronic device may turn off the vehicle at step S455.

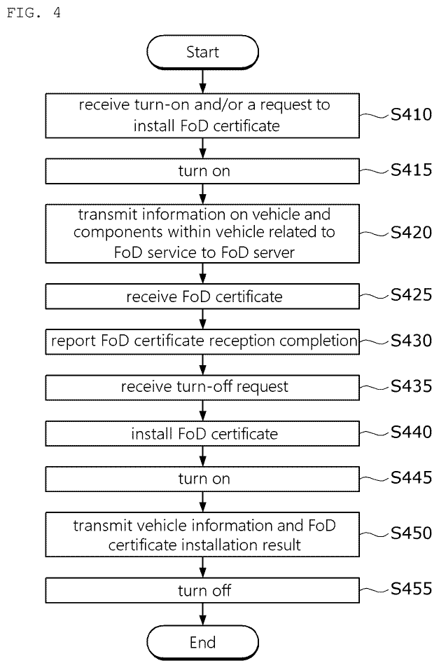

FIG. 5 is a block diagram of a first electronic device according to an embodiment of the present disclosure. The first electronic device may be associated with the operation method of FIG. 3.

With reference to FIG. 5, the first electronic device 110 may include a display 510, a communication unit 520, and a processor 530.

The display 510 may show results processed by the processor 530 and data received by the communication unit 520. For example, the display 510 may display applications installed on the first electronic device 110 or web pages accessed via the communication unit 520. The display 510 may also show the installation result of the FoD certificate. This installation result of the FoD certificate may include at least one of whether the FoD certificate was installed successfully, the validity period of the FoD certificate, or the installation date of the FoD certificate.

The communication unit 520 may communicate with the CCS server and/or the FoD server. The communication unit 520 may receive a request from the CCS server to activate a menu related to FoD certificate installation and receive the installation result of FoD certificate. The communication unit 520 may also communicate with the FoD server to purchase the FoD certificate or subscribe to the FoD service.

Connected to the communication unit 520, the processor 530 may purchase the FoD certificate or subscribe to the FoD service and request activation of menus related to the installation of the FoD certificate. The processor 530 may also activate menus related to the installation of the FoD certificate, request installation of the FoD certificate, and receive the installation result of the FoD certificate. Furthermore, the processor 530 may install applications related to the FoD service. Menus related to the installation of the FoD certificate may be one of the menus of the installed application, i.e., an application menu.

According to an embodiment, the installation result of the FoD certificate may include at least one of whether the FoD certificate was installed successfully, the validity period of the FoD certificate, or the installation date of the FoD certificate. This installation result of the FoD certificate may be displayed on the display 510 by the processor 530.

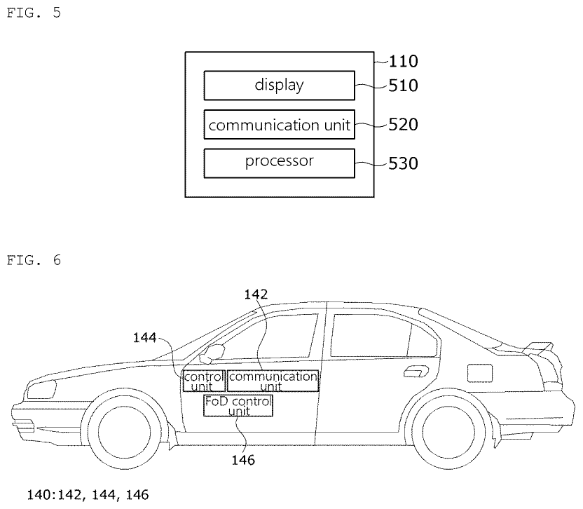

FIG. 6 is a block diagram of a second electronic device according to an embodiment of the present disclosure. THE second electronic device may be associated with the operation method of FIG. 4.

With reference to FIG. 6, the second electronic device 140 included in the vehicle may include a communication unit 142, a control unit 144, and an FoD control unit 146.

The communication unit 142 may communicate with the CCS server and/or the FoD server. The communication unit 142 may receive a request from the CCS server to turn on the vehicle, to install the FoD certificate, and to turn off the vehicle. The communication unit 142 may also receive the FoD certificate from the FoD server and transmit vehicle information and information about vehicle components related to FoD services to the FoD server. The communication unit 142 may also report the completion of FoD certificate reception to the FoD server and transmit the vehicle information and FoD certificate installation result. According to an embodiment, the communication unit 142 may also communicate with the first electronic device.

Connected to the communication unit 142 and the FoD control unit 146, the control unit 144 may receive requests to turn on the vehicle and install the FoD certificate and may then turn on the vehicle. The control unit 144 may transmit vehicle information and information about the components within the vehicle related to FoD services to the FoD server. The control unit 144 may receive the FoD certificate and report the completion of FoD certificate reception to the FoD server. The control unit 144 may turn off the vehicle. Upon completion of the installation of the received FoD certificate, the control unit 144 may turn the vehicle back on. The control unit 144 may transmit the vehicle information and FoD certificate installation result.

The FoD control unit 146 may install the received FoD certificate. Depending on the type and number of FoD services supported in the vehicle, there may be multiple FoD control units 146.

According to an embodiment, the vehicle information may include at least one of the vehicle manufacturer, vehicle specifications, vehicle model number, or vehicle manufacturing date. The information about the components within the vehicle related to the FoD service may include at least some of the necessary components within the vehicle to support the FoD service.

According to an embodiment, the installation result of the FoD certificate may include at least one of whether the FoD certificate was installed successfully, the validity period of the FoD certificate, or the installation date of the FoD certificate.

According to an embodiment of the present disclosure, users can remotely control the installation of FoD certificates without the need to directly board or physically interact with the vehicle.

According to an embodiment of the present disclosure, users can install FoD certificates without being constrained by time or location.

According to an embodiment of the present disclosure, enabling remote control of FoD certificate installation can enhance user convenience.

According to an embodiment of the present disclosure, users can install purchased FoD certificates from remote locations (e.g., from their homes) during times when the vehicle is not in use (e.g., late at night or early in the morning) and promptly verify the installation status.

Although the above description is directed to various embodiments, it is only given as an example and does not limit the present disclosure. Those having ordinary skill in the art to which the present disclosure belongs should understand that various modifications and applications not illustrated above are possible without departing from the essential characteristics of the present disclosure. For example, each component specifically illustrated in the embodiments may be modified and implemented. Differences related to these modifications and applications should be construed as being included in the scope of the present disclosure as defined in the appended claims.

### DESCRIPTION OF REFERENCE NUMERALS

110: first electronic device
120: CCS server
130: FoD server
140: second electronic device
142: communication unit
144: control unit
146: FoD control unit

What is claimed is:

1. A method for supporting feature on demand (FoD) services on an electronic device included within a vehicle, the method comprising:
receiving a request to turn on the vehicle and install an FoD certificate;
turning on the vehicle;
transmitting information on the vehicle and a component within the vehicle related to an FoD service to an FoD server;
receiving an FoD certificate;
reporting having received the FoD certificate to the FoD server;
turning off the vehicle;
installing the FoD certificate;
turning on the vehicle; and
transmitting the information on the vehicle and the installation result of the FoD certificate.

2. The method of claim 1, wherein:
the information on the vehicle comprises at least one of the manufacturer of the vehicle, the specification of the vehicle, the model number of the vehicle, or the manufacturing date of the vehicle; and
the information on the components with the vehicle related to the FoD service comprises at least some of the information about the components necessary within the vehicle to support the FoD service.

3. The method of claim 1, wherein:
the request to turn on the vehicle and install the FoD certificate is received from a connected car service (CCS) server; and
the information on the vehicle and the installation result of the FoD certificate is transmitted to the CCS server.

4. The method of claim 1, wherein the installation result of the FoD certificate comprises at least one of whether the FoD certificate was installed successfully, the validity period of the FoD certificate, or the installation date of the FoD certificate.

5. The method of claim 1, further comprising turning off the vehicle after transmitting the information on the vehicle and the installation result of the FoD certificate.

6. An electronic device included in a vehicle supporting feature on demand (FoD) services, the electronic device comprising:
a communication unit configured to communicate with a connected car service (CCS) server and a FoD server outside the vehicle and communicate among components inside the vehicle;
a control unit configured to receive a request to turn on the vehicle and install an FoD certificate, turn on the vehicle, transmit information on the vehicle and a component within the vehicle related to the FoD service to the FoD server, receive an FoD certificate, report having received the FoD certificate to the FoD server, turn off the vehicle, and transmit the information on the vehicle and the installation result of the FoD certificate; and
an FoD control unit configured to install the received FoD certificate.

7. The electronic device of claim 6, wherein:
the information on the vehicle comprises at least one of the manufacturer of the vehicle, the specification of the vehicle, the model number of the vehicle, or the manufacturing date of the vehicle; and
the information on the components with the vehicle related to the FoD service comprises at least some of the information about the components necessary within the vehicle to support the FoD service.

8. The electronic device of claim 6, wherein the control unit communicates with the CCS server to request to turn on the vehicle and install the FoD certificate and transmits the information on the vehicle and the installation result of the FoD certificate.

9. The electronic device of claim 6, wherein the installation result of the FoD certificate comprises at least one of whether the FoD certificate was installed successfully, the validity period of the FoD certificate, or the installation date of the FoD certificate.

10. The electronic device of claim 6, wherein the control unit turns off the vehicle after transmitting the information on the vehicle and the installation result of the FoD certificate.

11. A method for supporting feature on demand (FoD) services of an electronic device, the method comprising:
requesting to purchase an FoD certificate or subscribe to an FoD service;
receiving a request to activate a menu related to the installation of the FoD certificate;
activating the menu related to the installation of the FoD certificate;
requesting to install the FoD certificate; and
receiving the installation result of the FoD certificate.

12. The method of claim 11, wherein the menu related to the installation of the FoD certificate is an application menu of an application installed on the electronic device.

13. The method of claim 11, wherein requesting to purchase the FoD certificate or subscribe to the FoD service is performed through an application installed on the electronic device or a website accessed by the electronic device.

14. The method of claim 11, wherein the installation result of the FoD certificate comprises at least one of whether the FoD certificate was installed successfully, the validity period of the FoD certificate, or the installation date of the FoD certificate.

15. The method of claim 11, further comprising displaying the received installation result of the FoD certificate.
